(19) United States
(12) Patent Application Publication
(10) Pub. No.: US 2005/0165994 A1
(43) Pub. Date: Jul. 28, 2005

(54) Signal transmission over a wire pair

(76) Inventor: Nigel Anthony Dickens, Cambridge (GB)

Correspondence Address: STOEL RIVES LLP - SLC, 201 SOUTH MAIN STREET, ONE UTAH CENTER, SALT LAKE CITY, UT, 84111, US

(21) Appl. No.: 11/026,418

(22) Filed: Dec. 30, 2004

(30) Foreign Application Priority Data
Jan. 2, 2004 (GB) 0400011.3

(51) Int. Cl. G06F 13/14; H04N 17/02

(52) U.S. Cl. 710/305; 345/204

(57) ABSTRACT

An enterprise KVM system using single twisted pairs to transmit video and data signals is described together with circuitry for the parts of the system and a method of transmitting the signals. The method transmits a video signal and peripheral data over a single twisted pair between a computer and a plurality of peripherals. A sequence of a plurality of analogue video color signals with a vertical synchronisation signal following each analogue video signal is transmitted from the computer to the plurality of peripherals. Peripheral data is transmitted between the plurality of peripherals and computer during the vertical synchronisation signal transmission periods. The KVM enterprise system comprises a plurality of user stations, each user station including a keyboard, mouse and video display connected to a user interface. A plurality of computers are provided each connected to a dongle and supplying video, keyboard and mouse signals to the dongle. A KVM matrix switch is also included. Each of the dongles is connected to the matrix switch by a respective single twisted pair cable. Each of the user interfaces is connected to the matrix switch by a respective single twisted pair cable. Video signals and keyboard or mouse signals are transmitted via the twisted pair cables between any one of the plurality of computers and any one of the user stations.

### BACKGROUND OF THE INVENTION

The present invention relates to transmitting signals over cables between computers and peripherals, and in particular to transmitting video, and preferably peripheral, signals over a single pair of wires.

Keyboard, Video and Mouse (KVM) switches are used to connect a one or more KVM user stations, including a keyboard, video display and mouse to a plurality of computers so that a one or more users can remotely control a selected one of the plurality of computers. KVMA switches can also be provided which support audio also. One scenario in which KVM switches can be used is in enterprise hardware architectures in which a large number of users require access to a large number of computers. For example a typical enterprise solution would be required to have the ability to connect 8 users to 32 computers. Systems allowing 64 users to thousands of computers have been built.

Enterprise KVM systems typically use twisted pair network cable having RJ45 connectors in which the cable includes three twisted pairs for carrying the red, green and blue video signals and the fourth twisted pair being used to carry data signals. Audio signals are generally not supported.

However, the use of four twisted pair cable gives rise to a number of problems which are exacerbated as the size of the enterprise system increases. As each user needs to be able to control any one of the computers, the number of switches required is determined approximately by the number of users times the number of computers times the number of signals, which is four; three colour signals and one data signal. Hence increasing the number of users or computers increases the complexity and cost of the switching apparatus. Further, the sheer number of cables and amount of cabling required can cause significant problems.

There is therefore a need for a mechanism that reduces the amount of cabling required to provide reliable communication between a computer and a video display and input peripherals.

### SUMMARY OF THE INVENTION

According to a first aspect of the present invention, there is provided a method for transmitting video frames over a pair of wires between a video signal source and a display device. A sequence of analogue video colour signals is transmitted. Each analogue video colour signal is a single colour sample of a video frame. The analogue video colour signals can be stored. The stored video colour signals can be output to the display device. The display device can display the video frame in full colour.

By transmitting a sequence of monochromatic analogue video colour signals, storing the signals and then outputting the stored colour video signals to a display device to re-constitute a polychromatic video image, a single wire pair can be used to transmit a full colour video signal. The wire pair can be a co-axial cable, or preferably a twisted wire pair, or a single twisted wire pair in a multi-twisted wire pair cable.

Each analogue video colour signal in the sequence can be a line of the frame. Hence, each line in the video frame being transmitted is transmitted as a single colour.

The sequence can include all the analogue video colour signals for a single frame being the same colour. Hence, monochromatic video frames can be transmitted in the sequence.

The sequence can include all the analogue video colour signals for a single frame and being different colours. Hence, a polychromatic video frame can be transmitted, with the lines in the frame being different colours.

The sequence can include a vertical synchronisation signal following the analogue video colour signals for a single frame. The method can further comprise transmitting peripheral data during the vertical synchronisation signal transmission periods. Hence, the pair of wires can be used to transmit peripheral signals as well as video signals.

Three groups of analogue colour video signals can correspond to the full colour video frame. A first of the groups can correspond to red, a second of the groups can correspond to green and a third of the groups can correspond to blue. Hence a full colour image can be reconstituted from the three groups of monochromatic video signals. Each group can have consecutive members or the members of each group can be interspersed with members of the other groups. Fewer or more colours can be used depending on the number of colours required to re-constitute the full colour image.

The method can further comprise transmitting a plurality of horizontal synchronisation signals during each analogue video signal. A horizontal synchronisation signal can be provided subsequent to the colour video signal for each frame line.

An audio signal can be transmitted during the horizontal synchronisation signal period. Hence, a video signal and an audio signal can be transmitted over the same wire pair.

The audio signal can be a digital sample of a source audio signal. The audio signal can be provided as a plurality of bits overlaying or on top of the horizontal synchronisation signal. The bits can be represented by a negative polarity pulse.

A colour control signal can be transmitted during the horizontal synchronisation signal period which indicates the colour of the analogue video signal in the next analogue video signal following the horizontal synchronisation signal. The colour control signal can be provided by two bits. Three different combinations of the two bits can indicate three different colours.

A transmission mode control signal can be transmitted during the horizontal synchronisation signal period which indicates whether the signal following the horizontal synchronisation signal is an analogue video colour signal or a peripheral data signal. The transmission mode control signal can be a bit transmitted on the horizontal synchronisation signal. The transmission mode control signal can be the first of a plurality of bits transmitted on the horizontal synchronisation signal.

A data direction signal can be transmitted during the horizontal synchronisation signal period which indicates the direction of transmission of a peripheral data signal following the horizontal synchronisation signal. The data direction signal can be a bit transmitted on the horizontal synchronisation signal. The data direction signal can be a bit following the first of a plurality of bits transmitted on the horizontal synchronisation signal.

Peripheral data can be transmitted as a sequence of bits during a vertical synchronisation period and between horizontal synchronisation signals. The bits can be represented by a pulse train.

Vertical synchronisation signal data can be transmitted during a vertical synchronisation period and between horizontal synchronisation signals. The vertical synchronisation data can be sufficient to reconstitute a video source vertical synchronisation signal. The vertical synchronisation signal data can include the polarity and duration of a video source vertical synchronisation signal.

The method can include determining a video specification for the source video from the characteristics of the horizontal video synchronisation signal and vertical video synchronisation signal. Determining the video specification can include carrying out a look up operation on a look up table of video specification data.

The method can include adding to, or overwriting, the stored video signal with on screen display data for generating an on screen display on the display device.

According to a further aspect of the invention, there is provided a method for transmitting keyboard, video and mouse signals over a single twisted pair between a computer and a keyboard, video display and mouse. A sequence of three analogue video signal and vertical synchronisation signal groups is transmitted between the computer and video display. Each video signal corresponds to a source video frame. Keyboard and/or mouse data can be transmitted between the computer and keyboard or mouse during the period of each vertical synchronisation signal.

Hence in this was a KVM system can be provided using only a single pair of wires to transmit a full colour video signal and keyboard and/or mouse data.

According to a further aspect of the invention, there is provided a circuit for connecting a display device to a pair of wires over which a sequence of analogue video colour signals, each signal being a single colour sample of a video frame, can be transmitted. The circuit can comprise a receiver for receiving the sequence of analogue video colour signals. A first frame buffer and a second frame buffer are provided. Control logic can be provided and be configured to store a frame of received video colour data in a one of the first and second frame buffers and output a frame of colour video data from the other of the first and second video buffers to the display device.

According to a further aspect of the invention, there is provided a KVM enterprise system. The system can include a plurality of user stations, each user station including a keyboard, mouse and video display connected to a user interface. A plurality of computers can be provided, each computer connected to a dongle and supplying video, keyboard and mouse signals to the dongle. A KVM matrix switch can be provided, with each of the dongles being connected to the matrix switch by a pair of wires and each of the user interfaces being connected to the matrix switch by a pair of wires. Video signals and keyboard and/or mouse signals can be transmitted via pairs of wires between any one of the plurality of computers and any one of the user stations.

### BRIEF DESCRIPTION OF THE DRAWINGS

An embodiment of the invention will now be described, by way of example only, and with reference to the accompanying drawings, in which:

FIG. 1 shows a schematic block diagram of an enterprise KVM system according to an aspect of the invention;

FIG. 2 shows a schematic block diagram of a user interface part of the system shown in FIG. 1 according to a further aspect of the invention;

FIG. 3 shows a schematic block diagram of a computer interface part of the system shown in FIG. 1 according to a further aspect of the invention;

FIGS. 4A, 4B and 4C respectively show waveforms of an analogue video signal, horizontal synchronisation signal and control and digital audio signal handled by the circuit of FIG. 3;

FIG. 5 shows a schematic block diagram of a serial device interface part of the system shown in FIG. 1 according to a further aspect of the invention;

FIG. 6 shows a schematic block diagram of a matrix switch part of the system shown in FIG. 1 according to a further aspect of the invention;

FIG. 7A shows a graphical representation of the sequence of the signal transmitted over the twisted pair used in the system;

FIG. 7B shows an illustration of the wave form of the signal transmitted between vertical synchronisation periods of the signal illustrated in FIG. 7A;

FIG. 7C shows an illustration of the wave form of the signal transmitted during vertical synchronisation periods of the signal illustrated in FIG. 7A;

FIG. 7D shows an illustration of the waveform of a horizontal synchronisation signal part of the signal shown in FIGS. 7B and 7C and data bits superimposed thereon;

FIG. 7E shows an illustration of the waveform of a horizontal synchronisation signal part as shown in FIG. 7D transmitted during a video signal transmission part of the data sequence of FIG. 7A including video control data bits and digital audio data bits;

FIG. 7F shows an illustration of the waveform of a horizontal synchronisation signal part as shown in FIG. 7D transmitted during a vertical synchronisation period of the data sequence of FIG. 7A including data transfer control data bits and digital audio data bits; and

FIG. 8 shows a schematic block diagram of a computer end part of a further enterprise KVM system according to an aspect of the invention.

Similar items in different Figures share common reference numerals unless indicated otherwise.

### DETAILED DESCRIPTION OF THE INVENTION

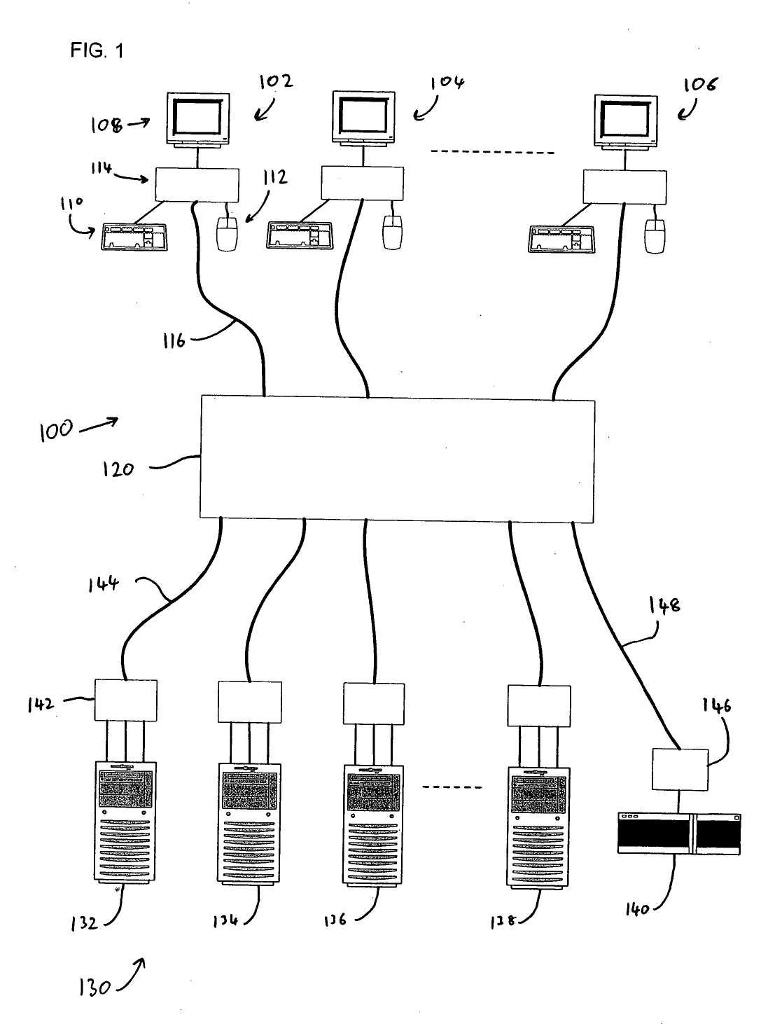

With reference to FIG. 1 there is shown an Enterprise KVM System 100. The Enterprise System includes a plurality of user stations, although only three, user stations 102, 104 and 106 are shown in FIG. 1. In practice, any number of user stations can be provided as appropriate for the requirements of the system. Each user station includes a video display unit 108, in the form of a computer monitor or similar, a keyboard 110 and a mouse 112. Other pointer devices can be used as part of the user station in place of mouse 112. The user station can also include other peripheral devices, such as audio speakers. Each user station also includes a user station interface device 114 to which the keyboard, mouse and monitor are each connected.

The Enterprise KVM System 100 also includes a matrix switching unit 120. Each user interface device 114 is connected by a single twisted pair cable 116 to the matrix switching unit 120.

KVM Enterprise System 100 also includes a plurality of computer devices 130. Any number of computer devices can be provided but in the illustrated embodiment four computers, 132, 134, 136 and 138 are shown. KVM Enterprise System 100 also includes a serial device in the form of a router 140. Each computer is also provided with a computer interface device, also referred to as a dongle 142. Dongle 142 is connected to the video, keyboard and mouse connectors of their respective computers by suitable cables. Each dongle is connected by a single twisted pair cable 144 to a connector on matrix switch 120. Router 140 also includes an interface device 146 and is also connected to switching unit 120 by a single twisted pair cable 148.

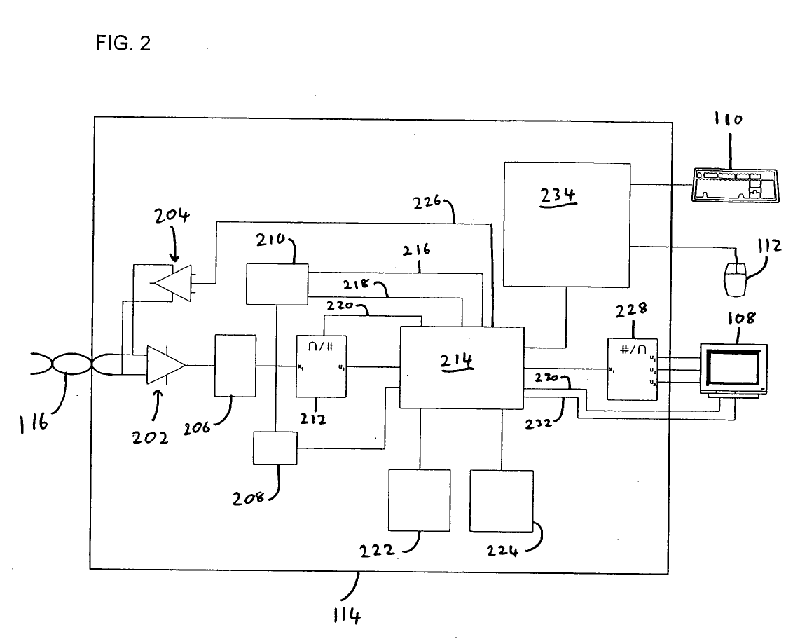

With reference to FIG. 2 there is shown a schematic block diagram of the user interface device 114. The circuitry of device 114 is illustrated in block diagram format to make it easier to explain the different functionalities provided by the circuitry. However, in practice some or all of the components may be incorporated into a greater or lesser number of components. Also, as will be appreciated by those of ordinary skill in the art, there are a number of ways in which the functionality of the circuit's components can be implemented in practice.

The circuitry of the user interface device 114 includes a connector for receiving the connector of the single twisted pair cable 116. The connector is in communication with the input to a differential twisted pair receiver circuit 202 and also with the output of a differential twisted pair transmitter circuit 204. The output of the receiver circuit 202 is connected to a line compensation circuit 206 which amplifies the received signal to compensate for its attenuation at a transmission over the twisted pair cable. The output of the compensation circuit 206 is passed to a thresholding circuit 208 and also to a synchronisation signal recovery circuit 210. The output of the compensation circuit 206 is also provided as an input to an analogue to digital convertor 212.

The user interface device 114 circuitry includes control circuitry implemented by the logic of a Field Programmable Gate Array (FPGA) 214. Control logic 214 is in communication with the output of thresholding circuitry 208, the output of the analogue digital converter 212 and a first output and a second output of the synchronisation signal recovery circuit 210. The first output 216 can present a recovered horizontal synchronisation signal and the second output 218 can present a recovered vertical synchronisation signal. The output of analogue to digital converter 212 presents a digital video colour data signal to FPGA 214. FPGA 214 is also in communication with analogue to digital converter (A/DC) 212 via an I2C bus 220 over which video capture set up signals can be transmitted to A/DC 212.

FPGA 214 is also in communication with memory 222 providing a first frame buffer and memory 224 providing a second frame buffer. First and second frame buffers 222 and 224 are preferably implemented in SDRAM. FPGA 214 is also in communication with the input to differential driver circuit 204 via line 226.

The user interface device 114 also includes a digital to analogue converter (D/AC) 228 in communication with an output of FPGA 214. In an alternate embodiment of the interface device, a DVI transmitter device is used in place of D/A 228 to support digital display devices. D/A converter 228 has three outputs each of which supplies a one of the red, green and blue video signals to display unit 108. A further output 230 of FPGA 214 supplies a vertical synchronisation signal to monitor 108 and a further output 232 of FPGA 214 supplies a horizontal synchronisation signal to monitor 108.

User interface device 114 also includes a microprocessor 234 in communication with FPGA 214 and also in communication with keyboard 110 and mouse 112 via conventional cables and connectors. Microprocessor 234 receives peripheral data signals from keyboard 110 and mouse 112 and also supplies peripheral data signals to keyboard 110 and mouse 112. The functioning of the interface device 114 will be described in greater detail below.

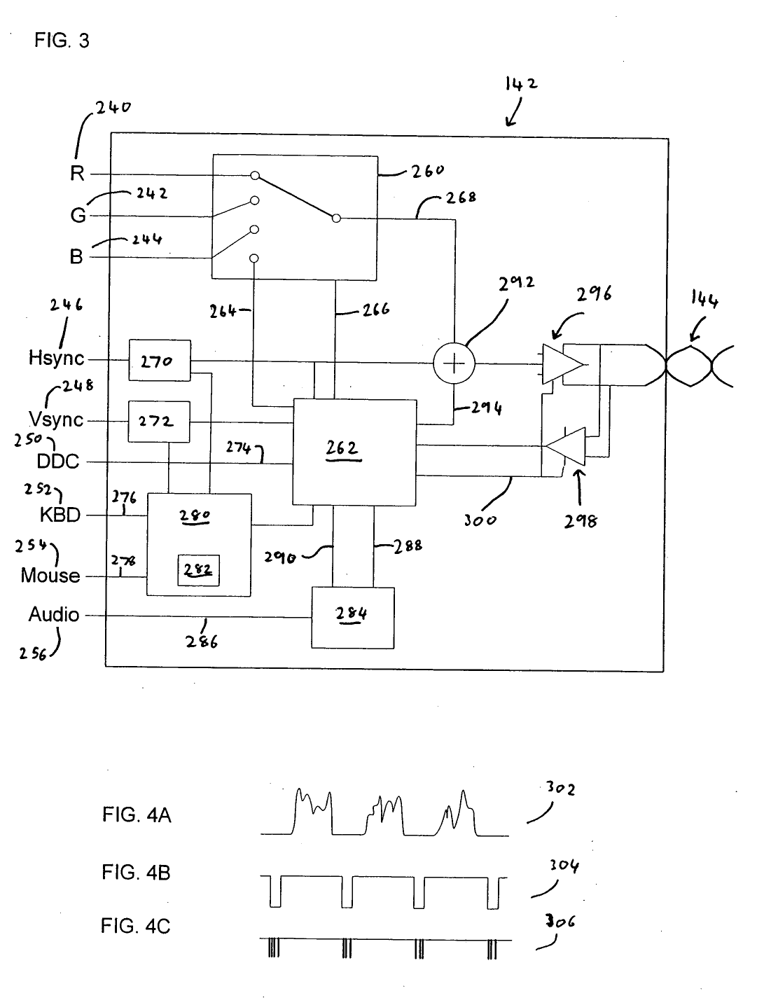

With reference to FIG. 3 there is shown a schematic block diagram of the circuitry of computer interface device, or dongle, 142. The dongle is connected to a monitor port on the computer 132 and supplied with red 240, green 242 and blue 244 analogue video colour signals, a horizontal synchronisation signal 246 and a vertical synchronisation signal 248. In some embodiments, the dongle is also supplied with a Display Data Channel (DDC) signal 250.

The dongle is also in communication with the keyboard port of the computer and a keyboard data signal 252 can be transmitted between the computer and dongle. Similarly, dongle 142 is connected to the computer mouse port and a mouse data signal 254 can be transmitted between the computer and dongle. An audio signal 256 can also be provided to dongle 142 from the computer speaker port.

The dongle circuitry includes a switch 260 which has the red, green and blue analogue video signals as three of its inputs. Some of the control circuitry of dongle 142 is provided by logic implemented in FPGA 262. An output of control circuitry 262 is connected to a fourth input at switch 260 by line 264. Line 264 supplies control and data signals to switch 260. FPGA 262 is also in communication with switch 260 via line 266 to provide a switching control signal to control which of the inputs of switch 260 is connected to the output 268 of switch 260.

The circuitry also includes a first 270 and a second 272 polarity detection and conversion circuit. The first receives the horizontal synchronisation signal (Hsync) as an input and the second 272 receives the vertical synchronisation signal (Vsync) as an input. Each of the circuits detects the polarity of the incoming synchronisation signal and, if necessary, converts the synchronisation signal to have a negative polarity. The negative polarity synchronisation signal is provided as an output from each of the circuits as an input to FPGA 262. The polarity signal, which indicates the polarity of the incoming synchronisation signal (i.e. positive or negative), is also supplied as an output from each of the polarity detection and conversion circuits 270, 272 to a microprocessor 280.

The polarity state of the original synchronisation signals can be communicated from the computer end interface to the user end interface using the data signalling channel that is also used to carry keyboard and mouse data signals. The polarity state data can be used by the user end circuit's FPGA to supply synchronisation signals with the same polarities to the monitor. In another embodiment, the synchronisation signal polarities can be derived from the VESA modes stored in the lookup table as described in greater detail elsewhere.

Microprocessor 280 has an onboard memory 282, in the form of an EEPROM. Memory 282 is used to store DDC information which is transmitted to the computer's monitor port over DDC line 274 as will be described in greater detail below. Microprocessor 280 receives and transmits keyboard signals 252 over line 276 and mouse signals 254 over line 278. An audio codec circuit 284 is also provided which receives audio data 256 over line 286. Audio codec circuitry 284 is in communication with FPGA 262 and transmits audio data over line 288 and receives a clock signal from FPGA 262 over line 290.

The dongle circuitry also includes a signal combining component 292 which receives as inputs the output of switch 260, the horizontal synchronisation plurality detection and conversion circuit 270 and an output 294 of FPGA 262. The output of signal combining circuit 292 is supplied as an input to a differential twisted pair driver 296, the output of which is connected to single twisted pair cable 144. The single twisted pair cable 144 is also connected to the inputs of a differential receiver circuit 298 the output of which is provided as a further input to FPGA 262. An output of FGPA 262 is also in communication via line 300 to the driver and receiver circuits 296, 298 to provide an enable signal inputting an exclusive OR function such that either driver 296 or receiver 298 is operational at any time.

FIG. 4A illustrates the wave form of the analogue video colour signal presented to signal combining circuit 292 as the output of switch 260 when connected to the red, green or blue analogue video signals. FIG. 4B shows the wave form of the negative plurality horizontal synchronisation signal presented as the second input to signal combining circuit 292. FIG. 4C shows the wave form 306 of the third signal supplied from the output of FPGA 262 presented to the third input of signal combining circuit 292. This signal has the general form of a negative plurality trough, with each trough representing a separate bit of information. This wave form is used to allow the transmission of digitised audio data as will be described in greater detail below.

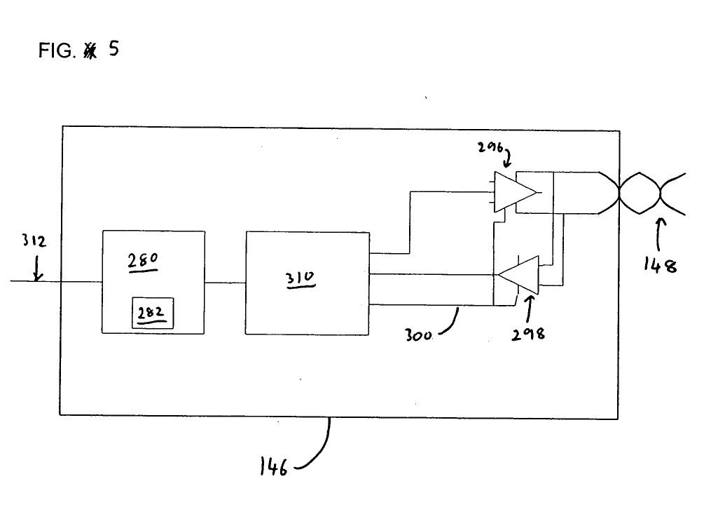

FIG. 5 shows a schematic block diagram of the circuitry of serial device interface unit 146 as shown in FIG. 1. This interface device is similar to interface device 142 and shares a number of common components. The interface device 146 also includes control logic implemented in FPGA 310 similar to that provided by FPGA 262. The interfacing device 146 also includes a microprocessor 280 including onboard memory 282. Microprocessor 280 is configured to receive and transmit serial data signals over line 312 by which interface unit 146 communicates with serial device 140. Serial device interface unit 146 allows for the transmission of control signals and data signals between serial device 140 and user stations 102, 104 and 106 via matrix switch 120 as will be described in greater detail below.

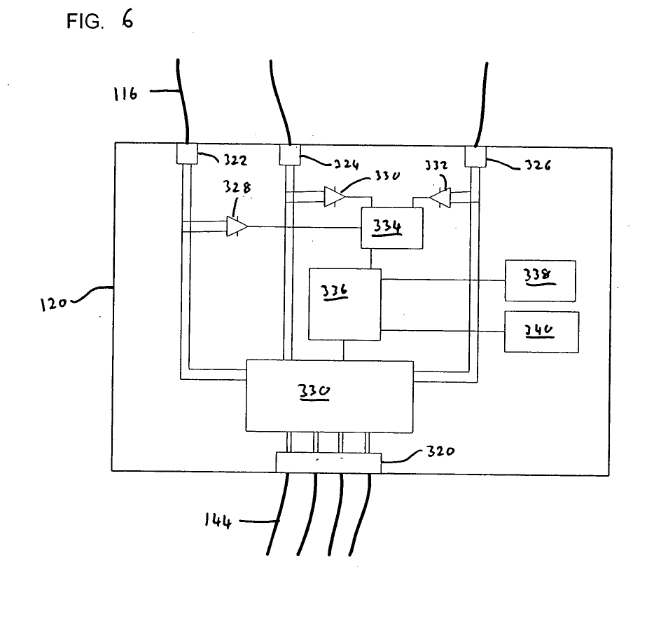

FIG. 6 shows a schematic block diagram of the circuitry of switching matrix 120. The matrix switching unit 120 as illustrated can support three users and four computers although in practice a greater number of users and computers can be supported. The extension of the described embodiment to support increased numbers of users and computers will be apparent from the following discussion.

Switching matrix 120 includes a connector 320 via which four single twisted pair computer cables can be connected to the switching unit 120. A standard RJ 458 twisted pair connector can be used to connect four separate computers to the switching unit as only one twisted pair per computer is required. A separate connector 320 can be provided for each group of four computers to be supported. This helps to minimise the amount of rack space required by the matrix switching unit 120. In conventional units, their size is typically governed by the large number of twisted pair connectors that need to be made available, usually to the rear of the panel.

The switching unit 120 includes a cross point switch 330. A first 322, second 324 and third 326 connector is provided by which a user single twisted pair cable, e.g. 116 can be connected to the switching unit 120. Each user connector is connected by signal lines to cross point switch 330. Cross point switch 330 is effective to connect any one of the four computer lines to any one of the three user lines. A buffer 328, 330, 332 is provided in communication with each user line so as to monitor the signals passing along these lines. The output of each buffer is communicated to control logic 334 implemented by a further FPGA. An output of FPGA 334 is provided as an input to a microprocessor 336 which outputs control signals to control the switching of cross point switch 330. Microprocessor 336 is also in communication with a key control circuit 338 and display device 340. Key control circuit 338 is in communication with a keypad via which a user can select the required routing of the cross point switch 330 and the display device 340 provides a visual indication of the routing status to the user.

The system of the current invention allows all the video colour information, keyboard and mouse data and audio signals to be transmitted using a single twisted pair of a twisted pair cable. This is achieved by transmitting the red, green and blue colour signals and the data signals in a specific sequence. In particular a sequence of monochromatic analogue video signals are sent. The minimum frame refresh rate for video signals is typically 60 Hz but the refresh rate is only this high in order to prevent screen flicker. In practice, an information update rate that is lower than this rate is acceptable. For example if information is updated at a rate of 20 Hz then this provides a usable video picture that is adequate for computer control.

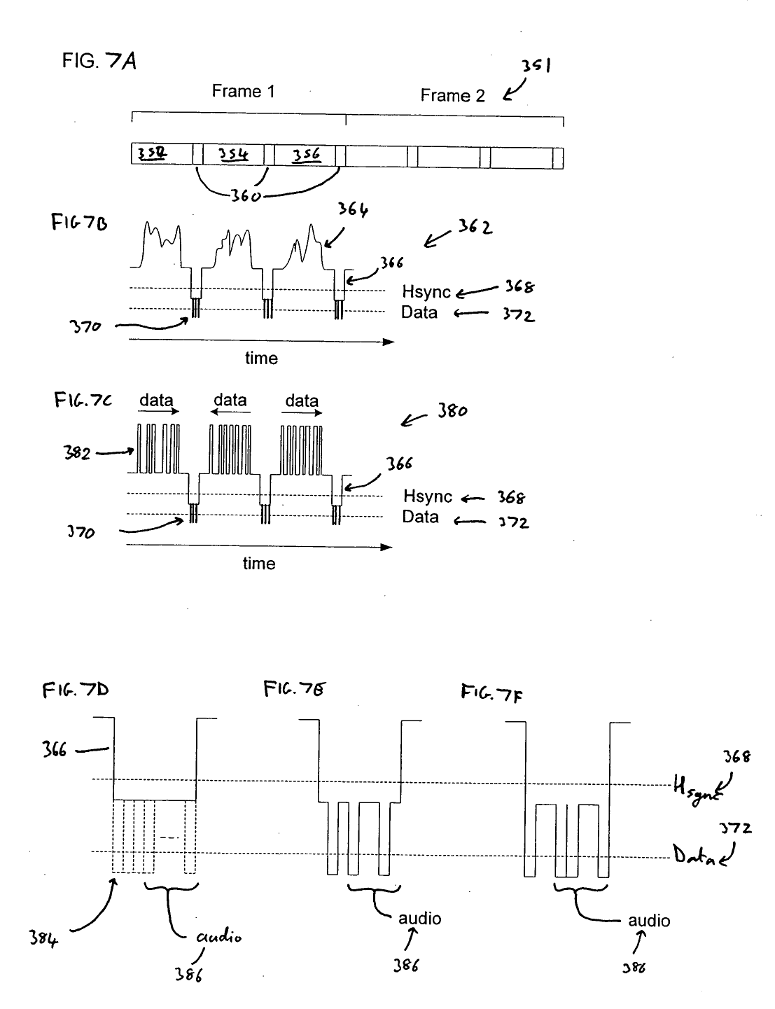

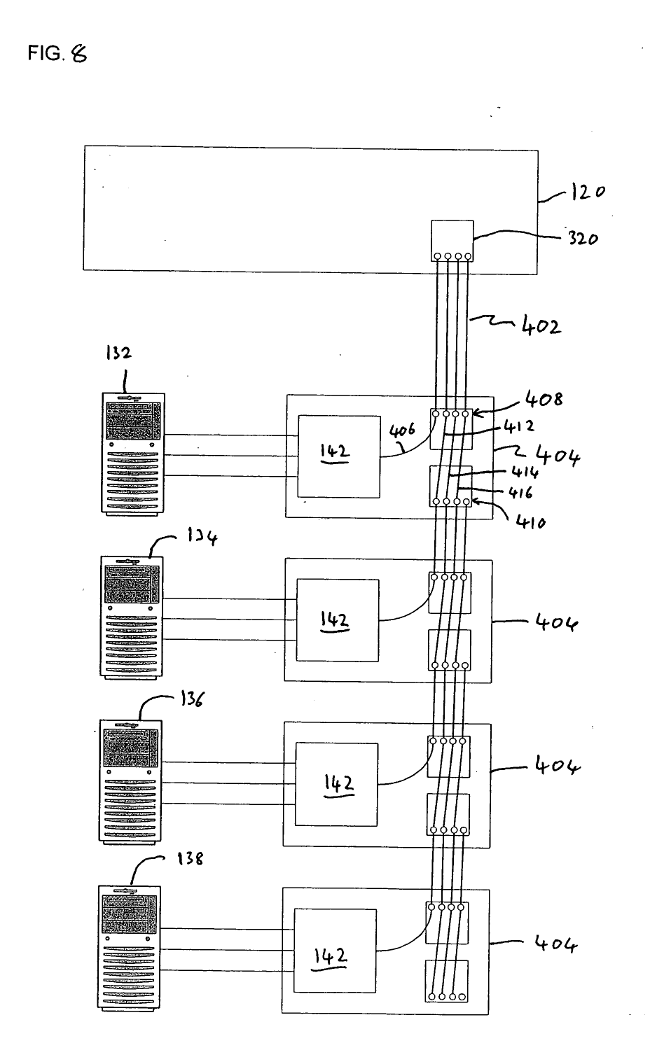

This is illustrated in FIG. 7A which illustrates how a video frame to be displayed on the user station is comprised of a sequence of three samples, 352, 354 and 356 of a source video frame from the computer interspersed by a vertical synchronisation period 360. As three source video frame samples are used to reconstitute the entire video frame at the user end, the effective refresh rate frequency is a third that of the original video frame, i.e. 20 Hz. Other effective refresh rates can be used, e.g. 15 Hz, 10 Hz, which would use a sequence of four and six frame samples respectively.

Hence the signal transmitted over the twisted pair comprises a sequence of analogue video signals each comprising a colour signal part separated by a vertical synchronisation signal part. Each analogue video signal part, e.g. 352, 354, 356 comprises an entire video frame, that is the analogue video colour signal for each line followed by a horizontal synchronisation signal period. FIG. 7B shows a plot against time of the signal transmitted over the twisted pair during each frame sample period 352, 354, 356. The signal 362 includes an analogue video colour signal part 364 each corresponding to a line of a video frame. Following each video colour signal is a horizontal synchronisation signal 366 in the form of a negative plurality trough pulse. A horizontal synchronisation signal threshold level 368 is set in the circuitry of the system to detect the horizontal synchronisation signal as will be described in greater detail below. The horizontal synchronisation signal pulse 366 also has encoded on it a number of bits for transmitting control and audio data signals 370 as will be described in greater detail below. A data signal threshold value 372 is used in the circuitry of the system to identify data signals.

In one embodiment, each sample 352, 354, 356 contains a single video colour signal. For example sample 352 may include red only video signals, sample 354 green only video signals and sample 356 blue only video signals. In an alternate embodiment, the video signals with a single sample can have different colours and different sequences. For example the first sample 352 can include red, green and blue video signal samples in that sequence. The second sample 354 can include green, blue and red video signals in that sequence and the third sample 356 can include blue, red and green video signals in that sequence. In this way, different colours in the displayed frame are updated for each received frame sample rather than updating the red colour signal information followed by the green colour information followed by the blue colour signal.

FIG. 7C shows the waveform of a signal 380 transmitted during the vertical synchronisation period 360 of the signal transmitted over the twisted pair. The signal similarly includes the horizontal synchronisation pulse signal 366 which again encodes data signals 370. However, in place of video signals 364, peripheral data signals 382 are encoded for transmission to or from the keyboard and/or mouse. Hence, during the vertical synchronisation signal period 360, peripheral data can be transferred between the computer and the user station.

FIG. 7D illustrates in greater detail how some of the control data and audio data is encoded on the horizontal synchronisation signal 366. The data is encoded as a plurality of bits each exceeding a data threshold value 372. A first bit 384 is used to indicate whether the signal is being transmitted during a vertical synchronisation period or not. In one embodiment when this bit is set at zero, the sync is not active and so the signal following the horizontal synchronisation signal can be identified as being video data. When bit 384 is set at 1, then this indicates that the signal following the horizontal synchronisation pulse is being transmitted during the sync period and therefore constitutes peripheral data.

FIGS. 7E and 7F illustrate these two scenarios respectively. When the first bit 384 is set to 0, then the second and third bits are used to encode the colour of the following video signal. In one embodiment, setting the second and third bits to 0 is used to indicate red, setting the second and third bits to 0 and 1 is used to indicate green and setting the second and third bits to 1 and 0 is used to indicate blue. FIG. 7E illustrates the scenario in which the second and third bits have been set to 1 and 0 indicating that the following signal is a blue colour signal. The bits 386 following the initial three bits are used to transmit digital audio data.

As illustrated in FIG. 7F when the first bit is set to 1, indicating that the subsequent signal is a peripheral data signal, then the second bit can be used to indicate the direction of transfer of the data. Setting the second bit to 0 can indicate that the subsequent data is to be transmitted from the computer to the peripheral (as illustrated in FIG. 7F) and setting the second bit to 1 can indicate that the subsequent data is to be transmitted in the direction from the peripheral to the computer. The third data bit is not significant and the fourth to last data bits are again used to transmit digital audio data.

The functioning of the circuitry of the parts of the Enterprise KVM System will now briefly be discussed.

With particular reference to FIG. 3, FPGA 262 controls switch 260 using switching control signal 266 to obtain three samples of the red, green and blue source video frame which are used to reconstitute the displayed video frame at the user end, but with a reduced colour information refresh rate frequency. Each frame sample is monochromatic. Between each of the source frame samples 352, 354, 356 and during the Vsync pulse period 360, the twisted pair is used to send data between the computer and peripherals. In a first embodiment, the first frame sample 352 is all red video data, the second sample 354 is all green video data and the third sample 356 is all blue video data. FPGA 262 switches switch 260 during the Vsync pulse period.

In another embodiment, FPGA 262 switches switch 260 during the Hsync period so as to sample a line of red video signal data followed by a line of green video signal data followed by a line of blue video signal data and then repeats that sequence for the frame sample. Hence although each sample is monochromatic, the frame sample as a whole is polychromatic, and in this embodiment tri-chromatic. For the next frame, firstly the blue signal is sampled, then the red signal then the green signal. For the third frame, firstly the green signal is sampled, then the blue signal and then the red signal. This strategy enables new colours to be displayed on the user's monitor at the end of each frame sample to provide a better image. Bits 2 and 3 of the control data 306 encoded on the Hsync pulse 304 are used, as explained previously, to indicate to the user's end circuitry the colour of the subsequent colour signal.

Circuit element 270 detects the plurality of the horizontal synchronisation pulse received from the computer and converts it to a negative plurality if not already negative. the negative plurality Hsync pulse train 304 is passed to combiner a circuit 292. FPGA 262 passes control and digital audio data signal 306 over line 294 to combine at 292 and the combined signal is passed to differential line driver 296 for transmission over twisted pair 144.

Even at low video frequencies, the repeat frequency of the Hsync pulse is sufficiently large to sample an audio stream and enable a good quality audio signal. The audio signal 256 is passed over line 286 to audio codec 284. Codec 284 receives a clock signal along line 290 from FPGA 262 and passes sampled digital audio data along line 288 to FPGA 262. The sampled digital audio data is superimposed on the Hsync pulses and transmitted as the fourth to last bits 386 encoded on the Hsync pulse. This is done for all the Hsync pulses including those that occur during the Vsync period.

The Vsync signal 248 from the computer is passed to the polarity detection circuit 272 which determines the polarity of the Vsync pulse and the duration of the Vsync signal. Data relating to the Vsync pulse is transmitted on top of each Hsync pulse coming form the computer during the Vsync period. The FPGA in the user end circuit uses this information to determine when Vsync is active and thereby can reconstitute the Vsync pulse at the user end. The FPGA 262 detects when the Vsync period is active and during that time sets switch 260 to connect to data line 264 to transmit digital data 382 instead of the analogue video colour signal 364. The keyboard signal 252 and mouse signal 254 from the computer are passed to microprocessor 280 along lines 276 and 278 respectively and the peripheral data to be transmitted is passed to FPGA 262 which is passed via line 264 and line 268 to summing circuit 292. Microprocessor 280 also outputs a signal to FPGA 262 indicating that the peripheral data is to be transmitted to the user end and the second bit of the control data is set accordingly and output on 294 to summing circuit 292. The first bit of the control data is also set by FPGA in response to the detected sync signal and output on line 294 to summing circuit 292. The audio signal is digitally sampled and provided as data bits 4 to the last data bit as described above.

During the Vsync period 360, the Hsync pulses provide sufficient time for the direction of the bus provided by the twisted pair to be reversed to allow data to be transmitted in both directions. Using the peripheral data direction data bit FPGA 262 can signal whether the subsequent peripheral data is being transmitted from the computer side or being received by the computer side and generates an enable signal 300 to either enable driver 296 to transmit over the twisted pair or receiver circuit 298 to receive a signal from the user end. Hence FPGA 262 effectively controls the data direction of the “bus”. When peripheral data is being received, the output of receiver circuit 298 is passed to FPGA 262 which extracts the relevant peripheral data which is passed to microprocessor 280 which outputs a keyboard signal 252 over line 276 and mouse signal 254 over line 278.

The signal output from dongle 142 is transmitted over a single twisted pair along a cable to the KVM switching matrix and routed via the cross point switch to the twisted pair cable connected to the user end interface of the appropriate user station. With particular reference to FIG. 2, the transmitted signal is received by receiver circuit 202 the output of which is passed to compensation circuit 206 which includes a line compensation amplifier that compensates for the loss introduced by the twisted pair line. The resulting clean signal is passed to analogue to digital converter 212 and the synchronisation signal recovery circuit 210. The synchronisation signal recovery circuit recovers the horizontal synchronisation signal and vertical synchronisation signal on the transmitted signals and passes them to FPGA 214. The sync recovery circuit can be provided as a part of FPGA 214. FPGA 214 is programmed to count the number of Hsync pulses received during a Vsync pulse period and the frequency of the Vsync pulses received. This information is communicated to microprocessor 234. Processor 234 uses this information to carry out a look up in a look up table of VESA standards to determine the corresponding VESA video standard. The processor 234 transmits appropriate video counter parameters through FPGA 214 which sets ADC 212 which enables ADC 212 to capture a clean digital image from the incoming analogue video signal. The captured video frame is stored in a one of the frame buffer memories 222, 224. The output of the other of the frame buffer memories is passed via FPGA 214 to DAC 228 which generates red, green and blue analogue signals which are supplied to monitor 108. FPGA also outputs the appropriate Hsync and Vsync signals over lines 230 and 232 to display monitor 108. In an alternative embodiment, a DVI transmitter device is used in place of DAC 228 and digital video data is transmitted directly to a digital display device.

Threshold circuitry 208 receives the output from the compensation circuitry 206 and supplies a signal to FPGA 214 to indicate when the received signal exceeds the data threshold so as to identify the bits of data encoded on the Hsync pulses.

FPGA 214 determines when Vsync is active and during this period ignores any signals from ADC 212 and instead reads digital data signals from threshold circuitry 208. The digital data received from threshold circuitry 208 is passed to microprocessor 234 and converted into appropriate keyboard and mouse data which is output to keyboard 110 and mouse 112 respectively. When the second data bit indicates that data is to be transmitted from the peripherals to the computer, then digital keyboard and/or mouse data is received from microprocessor 234 and passed via FPGA 214 over line 226 to driver 204 to transmit the peripheral data to the computer side.

Following the Vsync period, the first Hsync pulse having a first bit set to 0 is received indicating that further colour video data is being transmitted. FPGA 214 then outputs the content of the filled frame buffer to display unit 108 and stores the new frame data in the buffer storing the previously displayed frame. By switching between the first and second frame buffers, the refresh rate required by the monitor can be maintained even though data is being transmitted at a lower rate than the monitor refresh rate. Hence, switching between the frame buffers provides the refresh rate of the monitor as conventionally required, e.g. 60 Hz, but the rate at which colour information is updated is reduced, e.g. 20 Hz.

Microprocessor 234 also includes an on screen display (OSD) generating function which can be used to provide an on screen display on monitor 108. In an on screen display mode, the frame buffers are not filled by the output of ADC 212 and instead are filled by processors 234. This enables the processors to control each pixel displayed on monitor 108 and hence a more sophisticated on screen display can be provided to the user. In other embodiments, the microprocessor 234 does not overwrite the entire content of the frame buffer memory but rather overlays a part of the frame with the required on screen display so that both the video image from the computer and an on screen display image can be presented to the user.

Another feature of the system can be exploited when serial device 140 is connected to a user station via the KVM switching matrix. Device 140, such as a router, does not output a video signal but instead outputs a serial data signal which can correspond to an alpha numeric character. For example, the device can output a signal corresponding to the character K. That signal is encoded and transmitted as a digital data via the twisted pair cable. The digital data can be transmitted using any suitable bus protocol as there is no requirement, in this case, to send any video data as well. The signal is received and passed to processor 234 which determines what character the received serial signal corresponds to. The microprocessor then writes the appropriate character into the frame buffer memory so that the character can then be displayed locally on monitor 108. In this way, the display terminal 108 can emulate a terminal connected to a serial device even though no video data is being supplied from the serial device 140.

With reference to FIG. 3, DDC data is stored within EEPROM memory 282 of microprocessor 280. At power on, microprocessor 280 communicates this DDC information to the FPGA 262 which stores the data and sends the data to the computer's monitor port via DDC link 274 when requested. The communication of this DDC data emulates the action of a monitor connected directly to the computer and provides a trouble free boot-up for computers, such as those provided by Sun Microsystems, that do not provide a video signal if they cannot read DDC information at power-on.

Computer dongle 142 derives its power from the computer's keyboard port in a manner similar to that by which keyboards are conventionally powered. The serial device dongle 146 has no keyboard input and so is not powered in this way but rather a separate power supply or power line is provided for this unit.

With reference to FIG. 8 there is shown an arrangement by which four computers can be connected to KVM matrix switch 120 by a single or twisted pair cable 402 having conventional RJ45 connectors at each end. As the present invention allows the video and data signals to be transmitted over a single twisted pair, a standard network cable having four twisted pairs can be used to connect four computers to the KVM matrix switch 120. An interface unit 404 includes the computer interface circuitry 142 connected by a single twisted pair 406 to a standard RJ 45 connector 408. A second RJ 45 connector 410 is provided downstream of the upstream connector 408. The upstream and downstream connectors 408, 410 are connected by pairs of conductors 412, 414, 416 as illustrated in FIG. 8. In this way, a conventional four twisted pair cable with RJ 45 connectors can be used to interconnect each interface unit 404 and the final interface unit to the KVM switch thereby reducing the amount of cabling required compared to prior systems.

The present invention provides a large number of advantages and improved functionality. By using a single twisted pair for each connection, the invention significantly simplifies the required switching matrix and the transmitter and receiver line compensation circuitry, for example only one lot of drivers/receivers is needed rather than multiple ones. The computer end circuitry remains relatively simple because it is not expensive to implement a simple switching circuit to send just one of the colours during each Hsync line. The switching does not need to be fast because it only needs to be done at each Hsync pulse.

The complexity of the user end interface circuitry is increased because it needs to hold a digital image of the video picture in a frame store. However, this integrates well with the other functionalities of requirements of the invention because this same circuitry can be used to implement a good quality graphical OSD display and also to implement a terminal emulation window required for conversion of serial data to KVM data. The invention recognises that it is a good trade off in a multiuser-multicomputer Enterprise system to trade cabling and matrix switching simplicity for extra complexity in the user end interface module. This is because the numbers of computers is typically a lot more than the number of users (e.g. 1000 computers and 16 users).

By allowing a single twisted pair to be used to carry all the signals, the switching circuitry of the matrix switching unit is dramatically reduced.

When the number of users and computers exceeds the number that can practically be accommodated on a single matrix switching box, it is desirable to enable the Enterprise system to be expanded by linking matrix switching units. In order to ensure that the number of simultaneous users is maintained throughout the system then many multiple links must be made between switching boxes. These links are typically implemented by twisted pair links and so a separate twisted pair link is needed for each simultaneous user. For 64 users this makes a very complicated wiring problem both in terms of the bulk of the interconnect and the cost of the wire if conventional four twisted pair cable are used. By allowing a single twisted pair of wires to carry the signals for each user, a four twisted pair cable can be used to carry all the signals for 4 users. Therefore the cabling required to connect matrix switching boxes together is reduced by a factor of 4.

In conventional four twisted pair cables, the pairs of twisted pair wires have different twist rates to minimise cross talk. This causes a length difference that leads to colour skew (R, G and B colour signals arriving at different times) causing a colour splitting effect on the video screen. To compensate for this, sophisticated de-skew techniques are needed. However, in the present invention, as all the colour video signals are transmitted down the same twisted pair, there is no length difference and therefore no colour skew problem.

It is beneficial to be able to minimise the amount of rack space needed by a matrix switching unit. The size of the units is typically governed by the large number of twisted pair connectors that need to be presented on the product (usually on the rear panel). As each conventional RJ45 connector can be used to connect 4 computers, as illustrated in FIGS. 6 and 8, this reduces the size of the matrix switching unit compared to one supporting the same number of computers but requiring an RJ45 connector per computer.

Balanced transmitter circuitry, receiver circuitry and line compensation amplification would be needed for each of the colour signals and for each connection when a four twisted pair cable is used. This all adds to the cost of the system. The present invention allows the amount of circuitry to be reduced by a factor of 3 or more.

The present invention also provides an OSD display with good graphics capability. Off the shelf OSD devices have relatively limited graphics capability and good graphics is highly desirable for an Enterprise system where more information wants to be presented to the user. By providing a sophisticated OSD device in the processor used in the user end interface a sophisticated OSD can be provided to the user.

The ability to be able to control serial devices and KVM devices via a single KVM interface is an important feature for Enterprise KVM switches. To do this, the user end interface can convert the transmitted and received serial data into a KVM view using the processor to write to the content of the frame buffers on a pixel by pixel basis. The user end interface of the present invention can display a terminal window and create the graphical images for the characters being received or sent and having good resolution graphics.

The present invention also has the ability to support audio and so can also provide an Enterprise KVMA system.

1. A method for transmitting video frames over a single pair of wires between a video signal source and a display device, comprising:
transmitting a sequence of analogue video colour signals wherein each analogue video colour signal is a single colour sample of a video frame;
storing the analogue video colour signals in memory; and
outputting the stored video colour signals from memory to the display device so as to display the video frame in full colour.

2. A method as claimed in claim 1, wherein each analogue video colour signal in the sequence is a line of the frame.

3. A method as claimed in claim 2, wherein the sequence includes all the analogue video colour signals for a single frame being the same colour.

4. A method as claimed in claim 2, wherein the sequence includes all the analogue video colour signals for a single frame being different colours.

5. A method as claimed in claim 1, wherein the sequence includes a vertical synchronisation signal following the analogue video colour signals for a single frame, and the method further comprising transmitting peripheral data during the vertical synchronisation signal transmission periods.

6. A method as claimed in claim 1, wherein three groups of analogue colour video signals correspond to the full colour video frame.

7. A method as claimed in claim 1, further comprising transmitting a plurality of horizontal synchronisation signals during each analogue video signal.

8. A method as claimed in claim 7, further comprising transmitting an audio signal during the horizontal synchronisation signal period.

9. A method as claimed in claim 8, wherein the audio signal is a digital sample of a source audio signal.

10. A method as claimed in claim 7, further comprising transmitting a colour control signal during the horizontal synchronisation signal period which indicates the colour of the analogue video signal in the next analogue video signal following the horizontal synchronisation signal.

11. A method as claimed in claim 7, further comprising transmitting a transmission mode control signal during the horizontal synchronisation signal period which indicates whether the signal following the horizontal synchronisation signal is an analogue video colour signal or a peripheral data signal.

12. A method as claimed in claim 7, further comprising transmitting a data direction signal during the horizontal synchronisation signal period which indicates the direction of transmission of a peripheral data signal following the horizontal synchronisation signal.

13. A method for transmitting keyboard, video and mouse signals over a single twisted pair between a computer and a keyboard, video display and mouse, comprising:
transmitting a sequence of three analogue video signal and vertical synchronisation signal groups, wherein each video signal corresponds to a source video frame between the computer and video display; and
transmitting keyboard or mouse data between the computer and keyboard or mouse during the period of each vertical synchronisation signal.

14. A circuit for connecting a display device to a pair of wires over which a sequence of analogue video colour signals, each signal being a single colour sample of a video frame, can be transmitted, the circuit comprising:
a receiver for receiving the sequence of analogue video colour signals and producing an output signal;
a first frame buffer;
a second frame buffer; and
control logic in communication with the first frame buffer and second frame buffer, the control logic being configured to alternately store a frame of received video colour data in a one of the first and second frame buffers while outputting a frame of colour video data from the other of the first and second video buffers to the display device.

15. A KVM enterprise system comprising:
a plurality of user stations, each user station including a keyboard, mouse and video display connected to a user interface;
a plurality of computers, each computer connected to a dongle and supplying video, keyboard and mouse signals to the dongle;
a KVM matrix switch, wherein
each of the dongles is connected to the matrix switch by a respective single pair of wires and each of the user interfaces is connected to the matrix switch by a respective single pair of wires wherein video signals and keyboard or mouse signals are transmitted via respective single pairs of wires between any one of the plurality of computers and any one of the user stations.
